(19) United States
(12) Patent Application Publication
(10) Pub. No.: US 2009/0320878 A1
(43) Pub. Date: Dec. 31, 2009

(54) NON-WOVEN PRODUCT USED AS A WIPING CLOTH, METHOD AND INSTALLATION FOR THE PRODUCTION THEREOF

(75) Inventors: Frederic Noelle, St. Nazaire Les Eymes (FR); Saïd Serbi, La Ravoire (FR)

Correspondence Address: PEARNE & GORDON LLP, 1801 EAST 9TH STREET, SUITE 1200, CLEVELAND, OH, 44114-3108, US

(73) Assignee: RIETER PERFOJET, Montbonnot, FR (FR)

(21) Appl. No.: 12/306,747

(22) PCT Filed: Jun. 28, 2007
(86) PCT No.: PCT/FR07/01091

§ 371 Date: Dec. 29, 2008

(30) Foreign Application Priority Data
Jul. 7, 2006 (FR) 06 06213

(51) Int. Cl. B08B 7/00; D04H 5/02; B32B 5/00; B32B 3/10

(52) U.S. Cl. 134/6; 264/103; 428/219; 428/131

(57) ABSTRACT

This non-woven production installation comprises a spunbond tower (1), a device (7, 8) for consolidation by means of jets of water and a device (9, 10) for perforating by means of jets of water, the perforating device comprising three rows of jet outlet orifices.

### TECHNICAL FIELD

The present invention relates to non-woven products which have notable electrostatic characteristics, their production methods and their use as dry wiping cloths.

It is known to produce non-woven products which are used as wiping cloths and which have complex structures, for example, at least one sheet of continuous filaments which is hydraulically entangled with a sheet of discontinuous thermoplastic fibres.

This non-woven product has a high level of mechanical strength thanks to the properties of the sheets of filaments which are incorporated. Furthermore, these non-woven products which are subject to a corona discharge have lower decline of surface potential over time, which explains their good electrostatic quality and use as wiping cloths (EP 1 275 764).

The subject-matter of the present invention is a non-woven product having improved electrostatic characteristics, and has been found to be less costly and easier to produce using a method which also confers thereon a high level of mechanical strength.

The invention therefore relates to the use as a wiping cloth of a spunbond non-woven product of filaments of polypropylene structured with structures of from 1 to 3 mm in diameter with a structuring level indicating the ratio of the structured surface-area relative to the total surface-area of from 20 to 60%, the spacing between the structures, defined by the distance between the centres of the structures, being between 3 and 5 mm.

Preferably, the non-woven product has a traction tear strength in a first direction, that is to say, the direction of the machine, of between 100 and 150 N/50 mm, preferably between 110 and 130 N/50 mm, and, in a second direction perpendicular relative to the first one, therefore the cross direction, of between 80 and 120 N/50 mm, preferably between 90 and 110 N/50 mm.

Preferably, the non-woven product has an elongation of from 80 to 140%/10 N.

Preferably, the non-woven product has a surface potential decline of between 100 and 150 V in 600 seconds.

The filaments preferably have a denier of between 1.8 and 2 and 2.2, and preferably between 1.9 and 2.1.

Preferably, the non-woven product has a grammage of from 30 to 60 g/m², and in particular from 40 to 50 g/m².

According to a very preferred embodiment of the non-woven product used, the structures are apertures.

When an aperture is not circular, it is considered that the diameter thereof is the average of its largest dimension parallel with the surface of the non-woven product and its dimension perpendicular to the largest dimension thereof.

The invention also relates to a method for producing a non-woven sheet product, wherein:
a spunbond is prepared from filaments of polypropylene,
the sheet is consolidated by means of hydrobonding by applying jets of water to one of the faces thereof at a jet pressure of from 80 to 120 bar, preferably from 90 to 110 bar, to form a consolidated sheet,
the consolidated sheet is structured by applying jets of water to the other face of the sheet at a pressure of from 180 to 220 bar, preferably from 190 to 210 bar, from an injector having three rows of jets having a diameter of from 100 to 140 μm, preferably from 110 to 130 μm, the spaces between the outlet orifices of the jets in the same row being between 0.5 and 1.5 mm, the distance between the straight line extending through the centres of the outlet orifices of a row and the straight line extending through those of an adjacent row being between 0.25 and 1.2 mm and the distance between the perpendicular line relative to the straight line of a row extending through one of the orifices thereof and the perpendicular line relative to the straight line of an adjacent row extending through the closest orifice of the one orifice is between 0.25 and 0.75 mm and

The invention also relates to an installation comprising a spunbond tower, the bundle of filaments being extruded, drawn and deposited on a conveyor belt which conveys a sheet to a device for consolidation by means of jets of water which are projected onto one of the faces of the sheet in order to obtain a consolidated sheet which is in turn conveyed to a structuring device, in particular to a device for perforating, by means of jets of water. According to the invention, the structuring device is arranged so as to project jets onto the other face of the consolidated sheet and comprises three rows of jets having a diameter of from 100 to 140 μm, preferably from 110 to 130 μm, the spaces between the outlet orifices of the jets in the same row being between 0.5 and 1.5 mm, the distance between the straight line extending through the centres of the outlet orifices of a row and the straight line extending through those of an adjacent row being between 0.25 and 1.2 mm and the distance between the perpendicular line relative to the straight line of a row which extends through one of the orifices thereof and the perpendicular line relative to the straight line of an adjacent row extending through the closest orifice of the one orifice is between 0.25 and 0.75 mm.

The non-woven product obtained in this manner is dried in an oven with air intake and is then received on a roller device.

The passage speed of the non-woven product into the installation principally upstream of the perforating station is between 20 and 60 m per minute, preferably being between 20 and 50 m per minute. A speed which is too high may prevent the apertures from being produced.

The invention finally relates to a non-woven product as defined for the non-woven product used as a dry wiping cloth according to the invention.

Furthermore, according to the invention, in the non-woven product, the apertures preferably do not have any filaments extending through them.

According to an embodiment which is also preferred, the spaces between the apertures have at the surface no loops formed by filaments.

Preferably using the method and the installation defined above, a non-woven product is obtained which unexpectedly has all the qualities required to constitute a good wiping cloth and which in particular has a surface potential decline which is sufficiently slow for it to retain its dust and thread collecting properties by electrostatic means for as long as possible, which properties are conferred thereon by the simple friction which is used during the wiping operation. Unexpectedly, the occurrences of unevenness brought about by the apertures do not make the passage of the wiping cloth difficult over the surface to be wiped, in particular when the plain portions of the non-woven product no longer have hooking loops or other pilosity and the apertures improve the method of potential decline. A perforated cloth is in this respect more effective than a cloth which has a smooth surface. The invention also relates to a wiping method which involves wiping a surface using a non-woven product according to the invention.

The wiping cloth according to the invention may be used in particular to dry wipe all surfaces, in particular surfaces composed of metal, plastics material, ceramic material, glass and fabric in the following manner:

The cloth is held in one hand and applied to the surface to be cleaned with either rectilinear movement or small circular movements.

The laboratory tests for measuring thickness, density, strength in the longitudinal direction and in the crossdirection, elongation in the longitudinal direction and in the crossdirection, tearing in the longitudinal direction and in the cross direction, are carried out in accordance with the ERT standards of the EDANA (European Disposables and Nonwovens Association), that is to say:

a) Thickness

The sample is processed for 24 hours and the test is carried out at 23° C. at a relative humidity of 50%. The thickness of the non-woven product is measured by measuring the distance between a reference plate on which the non-woven product rests and a parallel pressing plate which applies a precise pressure to the surface which is being tested. The apparatus comprises two circular horizontal plates which are fixed to a frame. The upper plate moves vertically. It has a surface of approximately 2500 m². The reference plate has a planar surface having a diameter which is at least 50 mm greater than that of the upper plate. An item of equipment is provided which allows the component which is being tested to be suspended vertically between the two plates.

The test component has dimensions of 180×180 mm plus or minus 5 mm for the width and the length. A device is provided for measuring the distance between the plates when they are moved together up to the point at which a pressure of 0.02 kpa is applied.

b) Strength and Elongation in the Longitudinal Direction and in the Cross Direction

A sample is processed for 24 hours and the test is carried out at 23° C. and at a relative humidity of 50%. For the test, a dynamometer is used comprising a set of fixed jaws and a set of movable jaws which move at a constant speed. The jaws of the dynamometer have a useful width of 50 mm. The dynamometer is provided with a recording device which allows the line of the traction force to be indicated as a function of the elongation. Five samples are cut having a width of 50 mm plus or minus 0.5 mm and a length of 250 mm in the longitudinal direction and in the cross direction of the non-woven product. The samples are tested one by one, at a constant traction speed of 100 mm per minute and with an initial distance between the jaws of 200 mm. The dynamometer records the line of the traction force in Newtons as a function of the elongation.

c) Tear Resistance in the Longitudinal Direction and in the Crossdirection

A sample is processed for 24 hours and the test is carried out at 23° C. and at a relative humidity of 50%.

For the test, a dynamometer is used comprising a set of fixed jaws and a set of movable jaws which move at a constant speed. The jaws of the dynamometer have a useful width of 50 mm. The dynamometer is provided with a recording device which allows the line of the traction force to be indicated as a function of the movement of the movable jaws. Five samples are cut having a width of 75 mm plus or minus 1 mm and a length of 150 mm plus or minus 2 mm, in the longitudinal direction and in the crossdirection of the non-woven product. The large side of 150 mm is cut in the direction towards the machine or crossdirection to be tested. Two oblique lines are indicated which define an isosceles trapezium which has a base of 25 mm by a base of 100 mm and a height of 75 mm and whose bases are centred at 75 mm from the edges of the samples. A small cut of 5 mm is produced using scissors at the centre of the 25 mm base of each trapezium. This cut is intended to initiate tearing during the tests.

The samples are tested one by one. The jaws of the dynamometer are positioned at an initial distance of 25 mm. The sample is placed between the jaws so that the small base of the trapezium is slightly tensioned and the large base of the trapezium is relaxed.

The samples are tested at a constant traction speed of 100 mm per minute.

d) Mass Per Square Metre

A sample is processed for 24 hours and the test is carried out at 23° C. and at a relative humidity of 50%.

At least three samples are cut having a surface-area of at least 50,000 mm² with a guillotine-type cutting device.

Each sample is weighed on a laboratory scale having a level of precision of 0.1% of the mass of the samples weighed.

e) Decline of the Surface Potential

The decline of the surface potential is measured in the following manner.

The measurement of the surface potential decline (SPD) is carried out in two stages:

a) depositing ions (positive or negative) on the surface of the material,

b) measuring the potential at the surface of the material and recording this potential over time.

Step 1: A continuous voltage which is greater than or equal to ±3 KV is applied to a needle from a high-voltage power supply. This allows the air to be ionised in the region of the needle. This is known as “corona discharge”. For a positive (negative) voltage which is applied to the needle, positive (negative) ions are generated. It is therefore possible to deposit ions whose polarity can be controlled on the surface of an insulating material which is placed below this needle. The quantity of ions deposited will depend on the voltage and the duration of the corona discharge, the distance between the needle and the surface of the material and the climatic conditions (temperature and relative humidity) under which this corona discharge is carried out. In order to control this quantity of ions deposited, a metal grid which is connected to a high-voltage power supply is interposed between the needle and the material. The reference variable applied to this grid fixes the quantity of ions deposited, for example, if a voltage V_{décharge} is applied to the grid, the quantity of ions deposited on the surface gives an equivalent value of voltage on the surface of the material equal to V_{décharge}. That is to say, the ions generated by means of corona discharge pass through the grid and are deposited on the surface of the material until the potential at this surface reaches the value of the voltage applied to the grid. The other advantage of this grid is to allow the distribution of the ions at the surface of the material to be made homogeneous.

Step 2: After the ions have been deposited, they represent an “equivalent” voltage at the surface which is referred to as surface potential. An electrostatic sensor with no contact, positioned a few mm above the material, allows this surface potential to be measured. This electrostatic sensor is connected to an electrostatic voltmeter whose analogue output is connected to a computer which records the value of the potential as a function of the time elapsed since the ions were deposited. It is therefore possible to follow the flow of the ions on the surface from the development of this surface potential; this is referred to as a measurement of the surface potential decline. The measurement is averaged over a surface of at least 25 mm².

The complete system is composed of a motorised rotating plate (step motor) comprising four sample carriers. The movement of the sample carrier from the discharge station to the measurement station is thus automated and the movement speed is controlled. The application of the duration and the corona discharge voltage is also automated. The assembly is controlled by a programme. The device is installed in a climatic chamber which allows excellent control of the temperature conditions and relative humidity conditions desired.

The sample carrier is earthed, which means that the rear face of the sample is also in contact with earth.

Experimental Conditions

The experimental conditions used for all the samples are set out in the table below:

| Parameter | Value | |
|---|---|---|
| Voltage applied to the | 5 | KV |
| needle in order to produce | | |
| the corona discharge | | |
| Duration of the voltage to | 1 | second |
| produce the corona | | |
| discharge | | |
| Voltage applied to the | 2000 | V |
| distribution grid (V_{décharge}) | | |
| Time “lost” between the | ~2 | seconds |
| corona discharge and the | | |
| measurement of the | | |
| potential | | |
| Temperature in the chamber | 25° | C. |
| Relative humidity in the | 50% | |
| chamber | | |
| Time for processing a | 30 | minutes |
| sample in the chamber | | |
| before carrying out the | | |
| corona discharge | | |
| Duration of the measurement | 10 | minutes |
| of the surface potential | | |
| following a corona | | |
| discharge | | |

With regard to the appended drawings, given purely by way of example:

FIG. 1 is a schematic section of an installation according to the invention,

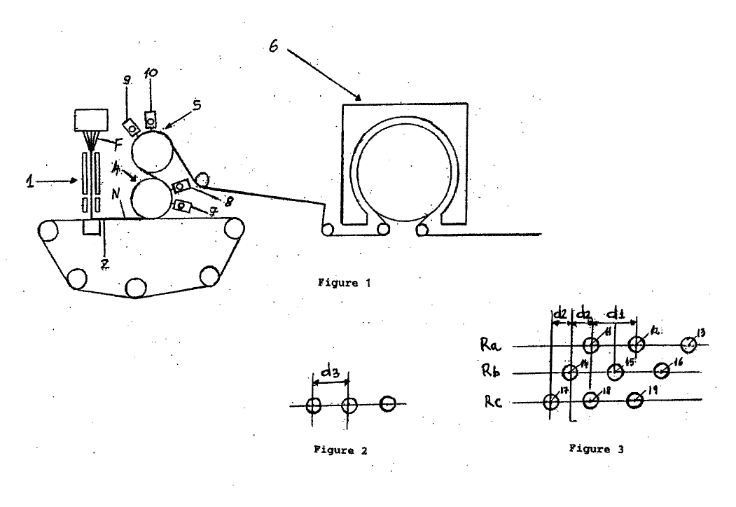

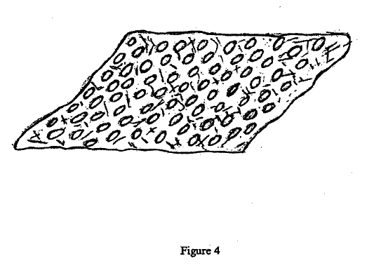

FIG. 2 is a diagram illustrating the respective position of the jet outlet orifices of the first perforating injector (9),

FIG. 3 is a diagram which is identical to that of FIG. 2, relating to the second perforating injector downstream of the first (10),

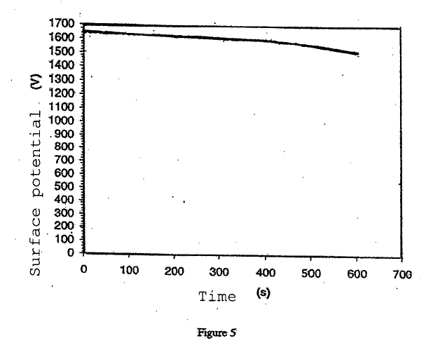

FIG. 4 is a plan view of an perforating non-woven product according to the invention,

FIG. 5 is the line of surface potential decline of the non-woven product according to the example.

FIG. 1 illustrates an installation according to the invention. It comprises a conventional spunbond tower 1 which provides on a conveyor belt 2 a non-woven sheet N which passes over two drums 4 and 5 and then over a drying drum 6.

Using two injectors 7 and 8, a conventional preconsolidation and consolidation operation is carried out in succession on the drum 4, over one face of the non-woven sheet N, by projecting jets of water.

The outlet orifices of the jets are arranged in two rows in each injector 7 and 8. They are staggered from one row to the next. The distance between two orifices of the same row is between 1.2 and 1.6 mm and preferably between 1.3 and 1.5 mm. A face of the non-woven product is obtained with no pilosity.

A perforating operation is carried out on the other face of the non-woven product on the drum 5 using injectors 9 and 10, respectively. The other face no longer has any pilosity.

FIG. 2 illustrates the position of the orifices of the jets of water on the injector 9. They are in a row with a spacing of the same size d3 as in the injectors 7 and 8, and preferably with identical spacing.

The distance between two adjacent outlet orifices of the jets of the injector 10 is designated d1 in FIG. 3. The distance between the perpendicular lines relative to the two straight lines which extend through the respective centres of two adjacent rows is designated d2 in FIG. 3, the perpendicular lines relative to the two straight lines extending through two adjacent holes of one row and the other.

More precisely, there are three rows, that is to say, a first row Ra, a second row Rb and a third row Rc of orifices, three of them being illustrated in each row. The row Ra thus has orifices 11, 12 and 13, the row Rb of orifices 14, 15 and 16 and the row Rc of orifices 17, 18 and 19. The centres of the orifices 11, 12, 13 extend through the same straight line, the centres of the orifices 14, 15, 16 extend through another identical straight line parallel with the first and the same applies to the orifices 17, 18, 19. The distance between the centre of an orifice 11 and that of the adjacent orifice 12 thereof is designated d1. The distance between the perpendicular line relative to the straight lines of the rows Ra, Rb and Rc which extend via the orifice 11 and the perpendicular line relative to these same straight lines which extend through the centre of the orifice 14 is designated d2.

Preferably, d1 is between 0.60 and 0.90 mm, whilst d2 is between 0.15 and 0.35 mm.

The diameter of the orifices is between 100 and 140 μm and, preferably, it is 120 μm.

Thanks to this arrangement of the jet outlet orifices, it is possible to prevent a hooking point on the non-woven product from being produced, which may be unpleasant for the user.

The following example illustrates the invention.

A sheet of continuous filament PP of 2 denier is subjected to the action of jets of water on an installation corresponding to FIG. 1, the speed of the jets of water is 50 m/minute, the pressure of the jets of water on the injectors 7 and 8 is 100 bar, the pressure of the jets of water on the injectors 9 and 10 is 200 bar.

The non-woven product obtained is dried at a temperature of 120° C. in an oven with air intake. A surface-area mass of 50 g/m² is obtained with apertures having a diameter of 2 mm, with an aperture ratio of 50%, the traction tear strength in the machine direction MD=140 N and CD=105 N, the thickness is 0.8 mm, the non-woven product is very soft and has a potential decline of 140 V/over 600 seconds.

1. Method for making a dry wiping cloth comprising using for making the cloth a spunbond non-woven product of filaments of polypropylene structured with structures of from 1 to 3 mm in diameter at a structuring level which indicates the ratio of the structured surface-area relative to the total surface-area of from 20 to 60%, the spacing between the structures, defined by the distance between the centres of the structures, being between 3 and 5 mm, the non-woven product having a traction tear strength in a first direction of between 100 and 150 N/50 mm and, in a second direction, perpendicular relative to the first, between 80 and 120 N/50 mm, as a dry wiping cloth.

2. Method for dry cleaning a surface, characterised in that the surface is wiped with a spunbond non-woven product of polypropylene filaments structured with structures of from 1 to 3 mm in diameter at a structuring level which indicates the ratio of the structured surface-area with respect to the total surface-area of from 20 to 60%, the spacing between the structures, defined by the distance between the centres of the structures, being between 3 and 5 mm, the non-woven product having a traction tear strength in a first direction of between 100 and 150 N/50 mm and, in a second direction, perpendicular relative to the first, of between 80 and 120 N/50 mm, as a dry wiping cloth.

3. Method according to claim 1 or 2, characterised in that the non-woven product has a traction tear strength in a first direction of between 110 and 130 N/50 mm and, in a second direction perpendicular relative to the first, of between 90 and 110 N/50 mm.

4. Method according to claim 1 or 2, characterised in that the filaments have a denier of between 1.8 and 2.2.

5. Method according to claim 1 or 2, characterised in that the structures are apertures.

6. Method according to claim 1 or 2, characterised in that the non-woven product has an elongation of between 80 and 140%/10 N.

7. Method according to claim 1 or 2, characterised in that the non-woven product has a surface potential decline of between 100 and 150 V in 600 seconds.

8. Method according to claim 1 or 2, wherein a surface of metal, plastics material, ceramic material, glass or fabric is wiped.

9. Method for producing a non-woven product, wherein
a spunbond sheet with a face is prepared from filaments of polypropylene,
the sheet is consolidated by means of hydrobonding by applying jets of water to its face at a jet pressure of from 80 to 120 bar, to form a consolidated sheet,
characterised in that the consolidated sheet is structured by applying jets of water to the other face of the sheet at a pressure of from 180 to 220 bar, from an injector having three rows of jets having a diameter of from 100 to 140 μm, the spaces between the outlet orifices of the jets of the same row being between 0.5 mm and 1.5 mm, the distance between the straight line extending through the centres of the outlet orifices of a row and the straight line extending through those of an adjacent row being between 0.25 and 1.2 mm and the distance between the perpendicular line relative to the straight line of a row extending through one of the orifices thereof and the perpendicular line relative to the straight line of an adjacent row extending through the closest orifice of the one orifice is between 0.25 and 0.75 mm.

10. Production installation for a non-woven product, comprising:
a spunbond tower which conveys a sheet to a device for consolidation by means of jets of water which are projected onto one of the faces of the sheet in order to obtain a consolidated sheet which is conveyed to a structuring device, in particular to a perforating device, by means of jets of water, characterised in that the structuring device is arranged so as to project jets onto the other face of the consolidated sheet and comprises three rows of jets having a diameter of from 100 to 140 μm, the spaces between the outlet orifices of the jets in the same row being between 0.5 and 1.5 mm, the distance between the straight line extending through the centres of the outlet orifices of a row and the straight line extending through those of an adjacent row being between 0.25 and 1.2 mm and the distance between the perpendicular line relative to the straight line of a row which extends through one of the orifices thereof and the perpendicular line relative to the straight line of an adjacent row extending through the closest orifice of the one orifice being between 0.25 and 0.75 mm.

11. Non-woven product of filaments of polypropylene structured by means of structures, of from 1 to 3 mm in diameter at a structuring level which indicates the ratio of the structured surface-area relative to the total surface-area of from 20 to 60%, the spacing between the structures defined by the distances between the centres of the structures being between 3 and 5 mm, the non-woven product having a traction tear strength in a first direction of between 100 and 150 N/50 mm and in a second direction perpendicular relative to the first of between 80 and 120 N/50 mm and a grammage of between 30 and 60 g per m², the potential decline being between 100 and 150 V.

12. Non-woven product according to claim 11, characterised in that the apertures do not have any filaments extending through them.

13. Non-woven product according to claim 11, characterised in that the spaces between the apertures have at the surface no loops formed by filaments.

14. Production installation for a non-woven product according to claim 10, wherein the structuring device is a perforating device.

15. Non-woven product of filaments of polypropylene according to claim 11, wherein said structures are apertures.
